(19) United States
(12) Patent Application Publication
(10) Pub. No.: US 2012/0203629 A1
(43) Pub. Date: Aug. 9, 2012

(54) Proposal Generator and Method for Creating a Proposal Offering One or More Outdoor Advertising Units Based on Buyer Criteria

(75) Inventors: Joshua Patrick Warrum, New York, NY (US); Samuel James Herbert, New York, NY (US); John Francis Laramie, New York, NY (US); Eliane Kabkab, New York, NY (US); Andrew Joseph Shults, New York, NY (US); Eric Isaiah Justusson, Brooklyn, NY (US); Neal Ranjan Shyam, Brooklyn, NY (US)

(73) Assignee: ADSTRUC, INC., New York, NY (US)

(21) Appl. No.: 13/367,007

(22) Filed: Feb. 6, 2012

Related U.S. Application Data
(60) Provisional application No. 61/439,620, filed on Feb. 4, 2011.
(60) Provisional application No. 61/590,723, filed on Jan. 25, 2012.

(51) Int. Cl. G06Q 30/02

(52) U.S. Cl. 705/14.49

(57) ABSTRACT

Some embodiments include a proposal generator and method for creating a proposal offering one or more outdoor advertising units based on buyer criteria. Other embodiments of related systems and methods are also disclosed.

### CROSS-REFERENCE TO RELATED APPLICATIONS

This application claims the benefit of U.S. Provisional Application No. 61/439,620, filed Feb. 4, 2011, and U.S. Provisional Application No. 61/590,723, filed Jan. 25, 2012. U.S. Provisional Application No. 61/439,620 and U.S. Provisional Application No. 61/590,723 are incorporated herein by reference in their entirety.

### FIELD OF THE INVENTION

The present invention relates to outdoor advertising, and more specifically, to systems and methods of requesting one or more automatically generated proposals offering outdoor advertising units suitable for supporting an advertising campaign of a buyer.

### DESCRIPTION OF THE BACKGROUND

Outdoor advertising is used effectively in advertising campaigns to reach a target audience, and may include any form of advertising found outside of the home. An advertising campaign brings together one or more forms of outdoor advertising throughout a geographic region in order to reach out to a target audience. However, deciding which of the outdoor advertising systems to include in a campaign or a proposal supporting a campaign is difficult, especially as the number of selectable systems is high. As the difficulty increases, suitable forms of outdoor advertising systems may be easily missed, thereby resulting in a poorly executed pitch for supporting an advertising campaign.

### BRIEF DESCRIPTION OF THE DRAWINGS

To facilitate further description of the embodiments, the following drawings are provided in which:

FIG. 1 illustrates a representative block diagram of a system, according to an embodiment;

FIG. 2 illustrates a flow chart for an embodiment of a method for generating a proposal;

FIG. 3 illustrates a computer system that is suitable for implementing an embodiment of the computer system; and

FIG. 4 illustrates a representative block diagram of exemplary components and/or circuitry included in exemplary circuit boards inside a chassis of the computer system of FIG. 3.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The term “outdoor advertising unit” can refer to data representative of a corresponding physical embodiment of an outdoor advertising system.

### DETAILED DESCRIPTION OF EXAMPLES OF EMBODIMENTS

Some embodiments include a system. The system comprises an inventory database aggregating multiple available outdoor advertising units and a proposal generator configured to communicate with the inventory database. The proposal generator comprises a criteria definition module, an information gatherer module, a unit inventory searcher module, a unit selector module, a reference locations definition module, a mapper module, a proposal assembler module, a proposal viewer module, and a notification module. The criteria definition module can define one or more criteria from which to select one or more outdoor advertising units, and the one or more outdoor advertising units can be suitable for implementing an advertising campaign associated with a buyer. The information gatherer module can define information related to the buyer and the advertising campaign. Meanwhile, the unit inventory searcher module can provide a selectable pool of outdoor advertising units from the multiple available outdoor advertising units based on the one or more criteria, and the unit selector module can select the one or more outdoor advertising units from the selectable pool of outdoor advertising units. The reference locations definition module can define at least one reference location. The mapper module can map the one or more outdoor advertising units and the at least one reference location to a map. The proposal assembler module can assemble (a) the information related to the buyer and the advertising campaign, (b) the map, and (c) the one or more outdoor advertising units into a proposal. The proposal viewer module can provide access to the proposal, and the notification module can provide notification of the proposal to one or more recipients.

Various embodiments include a system. The system comprises an inventory database means for aggregating multiple available outdoor advertising units and a proposal generator configured to communicate with the inventory database. The proposal generator comprises a criteria definition means, an information gatherer means, a unit inventory searcher means, a unit selector means, a reference locations definition means, a mapper means, a proposal assembler means, a proposal viewer means, and a notification means. The criteria definition module can define one or more criteria from which to select one or more outdoor advertising units, and the one or more outdoor advertising units can be suitable for implementing an advertising campaign associated with a buyer. The information gatherer module can define information related to the buyer and the advertising campaign. Meanwhile, the unit inventory searcher module can provide a selectable pool of outdoor advertising units from the multiple available outdoor advertising units based on the one or more criteria, and the unit selector module can select the one or more outdoor advertising units from the selectable pool of outdoor advertising units. The reference locations definition module can define at least one reference location. The mapper module can map the one or more outdoor advertising units and the at least one reference location to a map. The proposal assembler module can assemble (a) the information related to the buyer and the advertising campaign, (b) the map, and (c) the one or more outdoor advertising units into a proposal. The proposal viewer module can provide access to the proposal, and the notification module can provide notification of the proposal to one or more recipients.

Further embodiments include a method for generating a proposal, at least part of the method being implemented via execution of computer instructions configured to run at one or more processing modules and configured to be stored at one or more memory storage modules of a computer system, the method comprising: executing one or more first computer instructions to define one or more criteria used for selecting one or more outdoor advertising units, the one or more outdoor advertising units being suitable for implementing an advertising campaign associated with a buyer; executing one or more second computer instructions defining information related to the buyer and the advertising campaign; executing one or more third computer instructions defining a selectable pool of outdoor advertising units based on the one or more criteria, wherein the selectable pool of outdoor advertising units is defined from multiple available outdoor advertising units managed by one or more inventory management systems; executing one or more fourth computer instructions selecting the one or more outdoor advertising units from the selectable pool of outdoor advertising units; executing one or more fifth computer instructions mapping the one or more outdoor advertising units in a map; executing one or more sixth computer instructions assembling the information related to the buyer and the advertising campaign, the map, and the one or more outdoor advertising units into the proposal; and executing one or more seventh computer instructions notifying one or more recipients of the proposal. The computer instructions can comprise the one or more first, second, third, fourth, fifth, sixth, and seventh computer instructions.

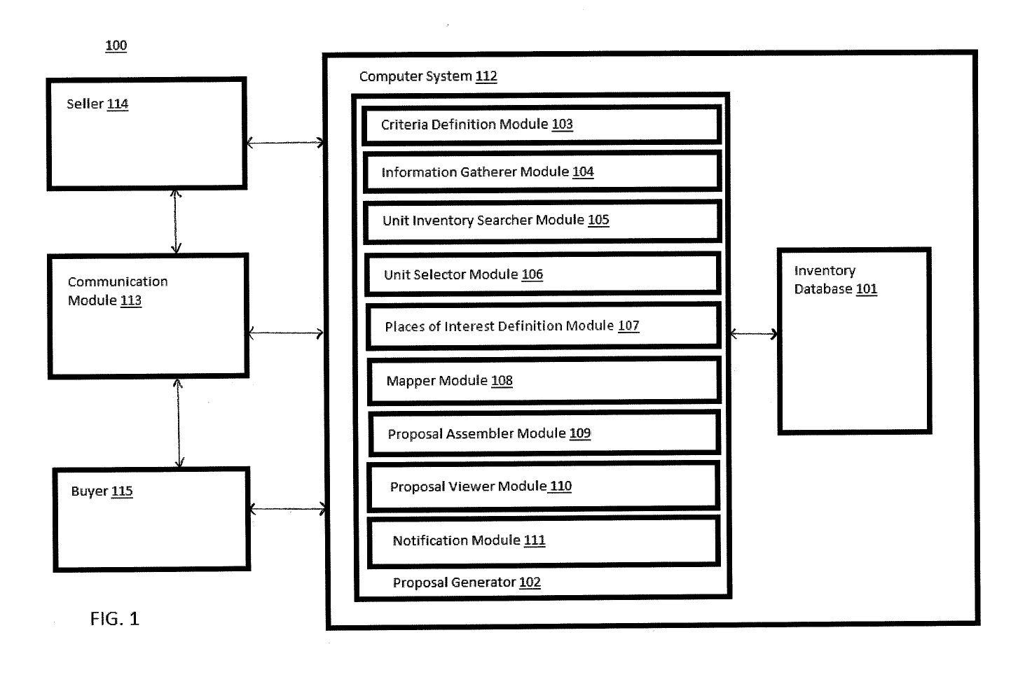

Turning to the drawings, FIG. 1 illustrates a representative block diagram of system 100, according to an embodiment. System 100 is merely exemplary and is not limited to the embodiments presented herein. System 100 can be employed in many different embodiments or examples not specifically depicted or described herein.

In many embodiments, system 100 can generate a request for proposal (RFP) and/or one or more proposals (e.g., corresponding to the RFP). The proposal(s) can comprise one or more outdoor advertising units that satisfy one or more criteria provided by a buyer. In some embodiments, system 100 can also locate (and/or provide as part of the proposal(s)) one or more outdoor advertising units associated with one or more places of interest (e.g., provided by the buyer), such as, for example, one or more competing business establishments.

In many embodiments, system 100 can generate the proposal(s) for one or more sellers (e.g., seller 114) of outdoor advertising units. The RFP can be generated and/or requested by a buyer (e.g., buyer 115) interested in implementing an advertising campaign. Meanwhile, the seller(s) can use system 100 to generate the proposal(s) in response to the RFP. The seller(s) can receive the RFP directly through system 100 (e.g., via an Internet portal associated with system 100) and/or indirectly through any suitable communication medium (e.g., electronic mail messaging, short message service text messaging, social network messaging, etc.).

In implementation, system 100 comprises inventory database 101 and proposal generator 102. In some embodiments, system 100 can comprise computer system 112 and/or communication module 113. Proposal generator 102 can comprise criteria definition module 103, information gatherer module 104, unit inventory searcher module 105, unit selector module 106, places of interest (POI) module 107, mapper module 108, proposal assembler module 109, proposal viewer module 110, and/or notification module 111.

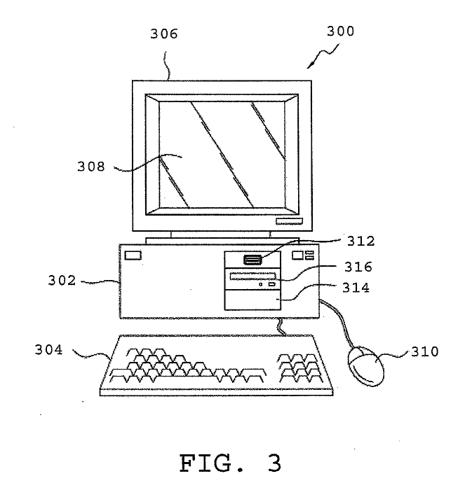

At least part of system 100 and/or proposal generator 102 can be operable at computer system 112. Accordingly, at least part of system 100 and/or proposal generator 102 can be implemented on software running at computer system 112 and/or can be implemented on specialized or dedicated hardware running on computer system 112. In further embodiments, inventory database 101 can be stored at one or more memory storage modules of computer system 112. Computer system 112 can be similar or identical to computer system 300 (FIG. 3).

Inventory database 101 can be implemented as any suitable computer database(s) (e.g., XML (Extensible Markup Language) database(s), MySQL database(s), and/or Oracle® database(s)). Inventory database 101 can aggregate (and/or store) multiple available outdoor advertising units for system 100. The multiple available outdoor advertising units (a) can be associated with one or more sellers of outdoor advertising systems and/or (b) can be managed by one or more inventory management computer systems. Accordingly, system 100 can operate cooperatively and/or communicate with the inventory management computer system(s). Each inventory management computer system can manage one (or multiple) seller's contribution(s)/share(s) of available outdoor advertising units to the multiple available outdoor advertising units. Each seller can own, lease, sell, and/or operate her respective available outdoor advertising units, and each of the available outdoor advertising units can be made available for inclusion in the proposal(s) generated by system 100 and/or proposal generator 102. Inventory database 101 can synchronize with the inventory management computer system(s) (e.g., periodically and/or in response to the occurrence of an event, such as, for example, upon generation of a request for an RFP by system 100) to update and/or re-aggregate the multiple available outdoor advertising units. Exemplary multiple available outdoor advertising units can comprise multiple of (a) one or more available aerial advertising units, (b) one or more available billboard advertising units, (c) one or more available wall-scape advertising units, (d) one or more available digital video advertising units, (e) one or more available indoor signage advertising units, (f) one or more available mobile advertising units, (g) one or more available phone booth advertising units, (h) one or more available poster advertising units, (i) one or more available street furniture advertising units, (j) one or more available transit advertising units, and/or (k) one or more available urban panel advertising units.

Inventory database 101 can also aggregate (and/or store) available outdoor advertising unit information related to each available outdoor advertising unit of the multiple outdoor advertising units. Exemplary available outdoor advertising unit information can comprise: (a) advertising campaign media types (e.g., aerial, billboard, wall-scape, digital video, indoor signage, mobile, telephone booth or call box, poster, street furniture (e.g., bus shelters), transit (e.g., moving objects), urban panel, alternative media formats, such as, for example, advertising at gas pumps and/or train and subway stations, etc.), (b) viewing direction (e.g., direction(s) (e.g., north, south, etc.) the available outdoor advertising unit faces), (c) related demographic information (e.g., age(s) of a target audience, income(s) of the target audience, etc.), (d) reach of the available outdoor advertising unit (e.g., defining an opportunity (e.g., a percentage chance) of the target audience to view the unit during an advertising campaign), (e) daily effective circulation (DEC) measurements, showing, latitude and longitude information, (f) illumination (e.g., whether the available outdoor advertising unit is illuminated), (g) identification number of the available outdoor advertising unit, (h) showing information, (i) region (e.g., state, county, city, etc.), (j) eyes on impression (EOI) measurements, etc. DEC measurements define the average number of persons potentially exposed to the available outdoor advertising unit over a period (e.g., 12 hours, or longer with illumination). Showing information is related to DEC measurements, and provides a definable level of delivery based on the population. EOI measurements define the average number of persons who are likely to notice an advertisement of an outdoor advertising unit.

Inventory database 101 can also store criteria defined by criteria definition module 103 and/or information related to the buyer and the advertising campaign gathered by information gatherer module 104. Criteria definition module 103 and information gatherer module 104 are described in greater detail below.

Proposal generator 102 can create the proposal(s) generated by system 100. Accordingly, proposal generator 102 is configured to communicate with inventory database 101 (e.g., via communication module 113) to reference the multiple available outdoor advertising units, the available outdoor advertising unit information, the criteria, and/or the information related to the buyer and the advertising campaign, as applicable, in order to create the one or more proposals for system 100. In some embodiments, proposal generator 102 can also communicate with the one or more inventory management computer system(s), one or more user computer system(s), and/or one or more inventory database computer system(s), such as, for example, via communication module 113. Each of the inventory management computer system(s) and/or the user computer system(s) can be similar or identical to computer system 300 (FIG. 3). In some embodiments, the user(s) (e.g., buyer(s) and/or seller(s)) of system 100 can directly access proposal generator 102 (and/or at least one of the inventory management computer system(s)) at computer system 112. In these or other embodiments, the user(s) of system 100 can remotely access proposal generator 102 (and/or at least one of the inventory management computer system(s)) at the user computer system(s). For example, system 100 and/or proposal generator 102 can be implemented as a centralized web based service/platform that manages the inventory of outdoor advertising units for the seller(s), and/or that generates proposal(s) using that inventory, such as in response to a buyer's RFP(s) supporting an advertising campaign. Notwithstanding the manner in which the user(s) of system 100 access proposal generator 102, system 100 and/or proposal generator 102 can facilitate the completion of the transaction(s), wherein the buyer is able to purchase outdoor advertising units in support of an advertising campaign. Accordingly, the user computer system(s) can be any suitable computer system(s) of the seller(s) and/or the buyer(s). In many embodiments, system 100 and/or proposal generator 102 can be used by user(s) via one or more graphical user interfaces. One or more of the modules of proposal generator 102 can also be in communication with each other, as applicable.

Communication module 113 can comprise a communication network comprising (a) one or more components configured to provide wired communication (e.g., one or more data buses, such as, for example, universal serial bus(es); one or more networking cables, such as, for example, coaxial cable(s), optical fiber cable(s), twisted pair cable(s); any other suitable data cable, etc.) and/or (b) one or more components configured to provide wireless communication (e.g., one or more radio transceivers, one or more infrared transceivers, etc.) between inventory database 101, proposal generator 102, the inventory management computer system(s), and/or the user computer system(s), as applicable. Communication module 113 can be configured to operate using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The components forming the communication network of communication module 106 can be dependent on the network topologies and/or protocols in use, and vice versa. In implementation, communication module 113 can be part of computer system 112, the inventory management computer system(s), the user computer system(s), and/or any other components with which communication module 113 is configured to permit communication (e.g., one or more inventory database computer systems comprising one or more memory storage modules storing inventory database 101 where not stored at one or more memory modules of computer system 112).

Criteria definition module 103 can define (and/or store at inventory database 101) one or more criteria from which to select one or more outdoor advertising units. In many embodiments, criteria definition module 103 can receive the criteria from (a) a buyer, such as, for example, as an RFP and/or (b) from the seller(s) (e.g., separately from the RFP). Accordingly, the outdoor advertising unit(s) can be suitable for implementing an advertising campaign associated with the buyer. In some embodiments, criteria definition module 103 can receive additional criteria from the seller(s) that may be attractive to the buyer, though not necessarily required by or even known to the buyer. These additional criteria can be used as additional selling points for the proposal(s). In addition to the receiving the criteria, proposal generator 102 and/or criteria definition module 103 can also receive a name for the RFP, a name of the buyer, contact information for the buyer, and/or any additional comments the buyer has regarding the advertising campaign. The criteria can be provided via one or more graphical user interfaces associated with criteria definition module 103.

Exemplary criteria can comprise (a) a budget of the buyer, (b) an advertising campaign start date, (c) an advertising campaign end date, (d) a requested response date, (e) one or more advertising campaign regions (e.g., cities, counties, states, etc.), (f) one or more advertising campaign media types, and/or (g) other advertising campaign details. Other advertising campaign details can comprise any demographic information related to the target audience (e.g., gender, age range, income, residence, population), and any other desired metrics (e.g., viewing direction, illumination, DEC measurements, EOI measurements, reach, showing, identification numbers, tags, etc.) attractive to the buyer. For example, the buyer can be an automobile manufacturer, and the advertising campaign can be directed to the promotion of a vehicle manufactured by the automobile manufacturer. Accordingly, the target audience can be identified as males between the ages of 18-35 having an average income of approximately $60,000 and living in New York, New Jersey, or Connecticut. The one or more advertising campaign regions help to define the area or region within which the buyer would like to advertise. The population defines the number of persons living within the market area. Meanwhile, in many embodiments, the criteria can also comprise at least one place of interest (e.g., business establishment(s)) to the buyer.

Accordingly, POI definition module 107 can define the place(s) of interest (e.g., as provided by a buyer as part of an RFP). In some embodiments, POI definition module 107 can be referred to as a references location definition module, and the place(s) of interest can be referred to as reference location(s). POI definition module 107 can receive the place(s) of interest as locations designated on an interactive map. The interactive map can be generated by mapper module 108. In many embodiments, the place(s) of interest can be received by POI definition module 107 from the buyer, such as, for example, by the buyer selecting the place(s) of interest on the interactive map. The buyer can also establish range(s) (e.g., a radius) around the place(s) of interest as part of the place(s) of interest criteria. Meanwhile, the seller(s) can reference the interactive map including the place(s) of interest and/or ranges for each of the place(s) of interest designated by the buyer when selecting using unit selector module 106 to select the outdoor advertising unit(s) from the selectable pool of outdoor advertising units, as described below. Mapper module 108 can map those available outdoor advertising units of the multiple available outdoor advertising units located within the ranges for each of the place(s) of interest designated by the buyer to facilitate the seller(s) ability to select the outdoor advertising unit(s) with unit selector module 108. In some embodiments, POI definition module 107 can be part of criteria definition module 103. For example, a buyer can define one or more coffee establishments as place(s) of interest on the interactive map and establish a one mile range around each of the coffee shops. Thus, where the buyer competes with the coffee establishment(s), the seller can select one or more outdoor advertising units appropriate for competing with the coffee establishment(s) (i.e., outdoor advertising units that are likely to target patrons of the coffee establishment(s)).

Information gatherer module 104 can define information related to the buyer and the advertising campaign. The information related to the buyer and the advertising campaign can be similar or identical to the criteria. Information gatherer module 104 can receive the information related to the buyer and the advertising campaign data (e.g., via text boxes and/or fields of one or more graphical user interface(s) associated with information gatherer module 104) from the seller(s) using proposal generator 102 and/or from inventory database 101 (e.g., automatically populating the information based on the criteria stored at inventory database 101).

Unit inventory searcher module 105 can provide a selectable pool of outdoor advertising units from the multiple available outdoor advertising units based on the one or more criteria. Unit inventory searcher module 105 can apply the criteria against the multiple available outdoor advertising units and filter out those units that satisfy the criteria, such as, for example, by comparing the criteria to the available outdoor advertising unit information. Thus, the selectable pool of outdoors advertising units can comprise outdoor advertisement units appropriate for the advertising campaign. Meanwhile, unit selector module 106 can select the outdoor advertising unit(s) from the selectable pool of outdoor advertising units, such as, for example, as provided for (e.g., selected) by the seller(s) using proposal generator 102. In some embodiments, unit inventory searcher module 105 can dynamically display the selectable pool of outdoor advertising units from which the seller(s) can select the one or more outdoor advertising units using unit selector module 106. Unit inventory searcher module 105 can provide a viewable picture of the outdoor advertising unit, a location of the outdoor advertising unit, and/or a description of the outdoor advertising unit for each of the outdoor advertising unit(s) of the selectable pool of outdoor advertising units to aid the seller(s) in selecting the outdoor advertising units with unit selector module 106. In many examples, the selectable pool of outdoor advertising units can be dynamically displayed on the interactive map as described above. Upon selecting one of the potential outdoor advertising unit(s) of the selectable pool of outdoor advertising unit(s), the seller(s) can view the viewable picture, location, and/or description of the outdoor advertising unit. In some embodiments, unit selector module 106 can be automated to select the outdoor advertising units as opposed to the seller(s) manually selecting the outdoor advertising units.

Accordingly, mapper module 108 can map the outdoor advertising unit(s) and/or the at least one place of interest to an interactive map, as described above. The interactive map can display the proximity of the place(s) of interest in relation to the outdoor advertising unit(s) to be included within a proposal created by proposal generator 102. Mapper module 108 can also generate an interactive map from which the buyer can select place(s) of interest via POI definition module 107, as described above. The interactive map used to select the place(s) of interest can be the same interactive map upon which mapper module 108 maps the outdoor advertising unit(s).

Proposal assembler module 109 can assemble (a) the information related to the buyer and the advertising campaign, (b) the map, and/or (c) the one or more outdoor advertising units into a proposal. In some embodiments, after the seller(s) selects the available outdoor advertising units via unit selector module 106 to include in the proposal(s), the proposal assembler module 109 can assemble the proposal. In addition to (a) the buyer related and advertising campaign information, (b) the map, and/or (c) the one or more outdoor advertising units, the proposal can also comprise any other suitable information. For example, the proposal can include any of the criteria (e.g., the budget of the buyer), a total property cost for the outdoor advertising units over the duration of the advertising campaign (e.g., as defined by the advertising campaign start date and end date), an installation cost for the outdoor advertising units, a total cost of the outdoor advertising units included in the proposal (e.g., such that the buyer is able to compare the total cost to the budget of the buyer), etc. In many embodiments, the seller(s) can continue to view the viewable pictures, locations, and/or descriptions of the outdoor advertising units via the proposal. In further embodiments, proposal assembler module 109 can also assemble the RFP provided by the buyer.

Meanwhile, proposal viewer module 110 can provide access to the proposal (e.g., to the buyer and/or the seller(s)). For example, after proposal assembler module 109 assembles the proposal, proposal viewer module 110 can make the proposal available to one or more intended recipients, such as, for example, via an Internet portal associated with system 100. For example, the buyer and/or seller(s) can access an Internet website including the proposal and located at the Internet portal by activating a unique link associated with the Internet website and providing access to the website. In many embodiments, the website can aggregate the proposal(s) and any subsequently generated proposal(s) for a given RFP into a unified proposal. For example, each time a seller responds to a buyer's RFP, the buyer gets a new notification (e.g., via notification module 113) and the seller's proposal is integrated into a single proposal (rather than multiple separate proposals). In further embodiments, the buyer can also select and view any specific seller's proposal from the unified proposal. In some embodiments, proposal viewer module 110 can also provide access to the RFP (e.g., to the buyer and/or the seller(s)).

Likewise, notification module 111 can provide notification of the RFP and/or the proposal to one or more (e.g., interested) recipients, as applicable. In some examples, the recipient(s) can comprise the buyer and/or can be associated with the buyer. In these or other examples, the recipient(s) can comprise at least one of the seller(s). Notification module 111 can provide notification of the proposal to the recipient(s) via any suitable communication mechanism (e.g., electronic mail messaging, short message service (SMS) text messaging, social network messaging (e.g., a message board), etc.). In many embodiments, notification module 111 permits the recipient(s) to be selected via one or more graphical user interfaces associated with notification module 111. For example, the seller(s) can enter electronic mail address(es) of the intended recipient(s) of the proposal (e.g., buyer@company.com and/or buyer2@company.com) via. Also, a personal message can be included in the notification message, as provided in the text box or field of the graphical user interface(s). While in some embodiments, the seller(s) can only designate buyer(s) having submitted RFP(s) as recipient(s), in other embodiments, the seller(s) can designate any buyer(s) as recipient(s), regardless of whether the buyer(s) submitted RFP(s).

Accordingly, notification module 111 can automatically provide the unique link (and the personal message, when applicable) of the proposal to the recipient(s) via the relevant communication mechanism(s). The notification message is delivered, along with a personal message if provided, to the specified and intended recipients. See comment in the previous paragraph. By clicking on the unique link, the recipient(s) are connected (e.g., via communication module 113) to a secure website displaying the seller's proposal.

Proposal generator 102 can also comprise a transaction module allowing the buyer to complete a transaction with the seller(s). That is, if the buyer is satisfied with the terms of the proposal, the buyer can indicate her acceptance of a proposal using one or more graphical user interfaces associated with the transaction module.

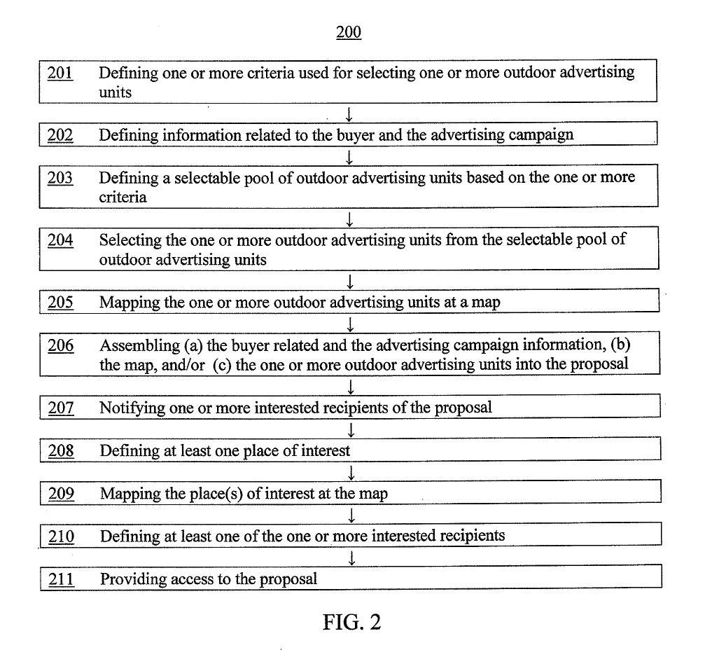

FIG. 2 illustrates a flow chart for an embodiment of method 200 for generating a proposal. Method 200 is merely exemplary and is not limited to the embodiments presented herein. Method 200 can be employed in many different embodiments or examples not specifically depicted or described herein. In some embodiments, the procedures, the processes, and/or the activities of method 200 can be performed in the order presented. In other embodiments, the procedures, the processes, and/or the activities of method 200 can be performed in any other suitable order. In still other embodiments, one or more of the procedures, the processes, and/or the activities in method 200 can be combined or skipped. The proposal can be similar or identical to the proposal(s) described above with respect to system 100 (FIG. 1).

At least part of method 200 can be implemented via execution of computer instructions configured to run at one or more processing modules and configured to be stored at one or more memory storage modules of a computer system. The computer system can be similar or identical to computer system 112 (FIG. 1) and/or computer system 300 (FIG. 3). Accordingly, some or all of the procedures, processes, activities, etc. of method 200 can comprise symbolic representations of computer instructions on data bits that can be performed on the computer system. These computer instructions can lead to one or more desired results and/or provide one or more desired functions. The computer instructions can comprise physical manipulations of physical quantities. These physical quantities can take the form of electrical or magnetic signals capable of being stored, transferred, combined, compared, and otherwise manipulated in a computer system. These signals can be referred to as data bits, values, elements, symbols, characters, terms, numbers or the like.

Method 200 can comprise procedure 201 of defining one or more criteria used for selecting one or more outdoor advertising units, such as, for example, with a criteria definition module. The criteria definition module can be similar or identical to criteria definition module 103 (FIG. 1), and the criteria can be similar or identical to the criteria described above with respect to criteria definition module 103 (FIG. 1). Meanwhile, the outdoor advertising units can be similar or identical to the outdoor advertising units described above with respect to system 100 (FIG. 1). In some embodiments, procedure 201 can comprise receiving the one or more criteria from the buyer.

Method 200 can comprise procedure 202 of defining information related to the buyer and the advertising campaign, such as, for example, with an information gatherer module. The information gatherer module can be similar or identical to information gatherer module 104 (FIG. 1), and the information related to the buyer and the advertising campaign can be similar or identical to the information related to the buyer and the advertising campaign described above with respect to information gatherer module 104 (FIG. 1).

Method 200 can comprise procedure 203 of defining a selectable pool of outdoor advertising units based on the one or more criteria, such as, for example, with a unit inventory searcher module. The selectable pool of outdoor advertising units can be defined from multiple available outdoor advertising units managed by one or more inventory management computer systems. The unit inventory searcher module can be similar or identical to unit inventory searcher module 105; the selectable pool of outdoor advertising units can be similar or identical to the selectable pool of outdoor advertising units described above with respect to unit inventory searcher module 105 (FIG. 1); the multiple available outdoor advertising units can be similar or identical to the multiple available outdoor advertising units described above with respect to inventory database 101 (FIG. 1); and/or the inventory management computer system(s) can be similar or identical to the inventory management computer system(s) described above with respect to system 100 (FIG. 1).

Method 200 can comprise procedure 204 of selecting the one or more outdoor advertising units from the selectable pool of outdoor advertising units, such as, for example, with a unit selector module. The unit selector module can be similar or identical to unit selector module 106 (FIG. 1).

Method 200 can comprise procedure 205 of mapping the one or more outdoor advertising units at a map (e.g., an interactive map), such as, for example, with a mapper module. The mapper module can be similar or identical to mapper module 108 (FIG. 1), and the map can be similar or identical to the map described above with respect to mapper module 108 (FIG. 1).

Method 200 can comprise procedure 206 of assembling (a) the information related to the buyer and the advertising campaign, (b) the map, and/or (c) the one or more outdoor advertising units into the proposal, such as, for example, with a proposal assembler module. The proposal assembler module can be similar or identical to proposal assembler module 109 (FIG. 1).

Method 200 can comprise procedure 207 of notifying one or more (e.g., interested) recipients of the proposal, such as, for example, with a notification module. The proposal viewer module can be similar or identical to proposal viewer module 110 (FIG. 1). In some embodiments, procedure 207 can comprise notifying the recipient(s) of the proposal via at least one of electronic mail messaging, short message service text messaging, or social network messaging. The recipient(s) can be similar or identical to the recipient(s) as described above with respect to notification module 111 (FIG. 1).

Method 200 can comprise procedure 208 of defining at least one place of interest (e.g., at least one reference location), such as, for example, with a places of interest (POI) module. The POI module can be similar or identical to POI module 107 (FIG. 1), and the place(s) of interest can be similar or identical to the place(s) of interest described above with respect to POI module 107 (FIG. 1). In some embodiments, procedure 208 can comprise receiving the place(s) of interest from the buyer. In some embodiments, procedure 208 can be performed as part of procedure 201. In some embodiments, procedure 208 can be omitted.

Method 200 can comprise procedure 209 of mapping the place(s) of interest (e.g., the reference location(s)) at the map. Procedure 209 can comprise mapping one or more ranges associated with the place(s) of interest at the map. The range(s) can be similar or identical to the range(s) described above with respect to mapper module 108 (FIG. 1).

Method 200 can comprise procedure 210 of defining at least one of the one or more recipients.

Method 200 can comprise procedure 211 of providing access to the proposal, such as, for example, with a proposal viewer module. The proposal viewer module can be similar or identical to proposal viewer module 110 (FIG. 1).

In some embodiments, procedures 201 through 211 can be performed in the sequence provided. However, in other embodiments, one or more of procedures 201 through 211 can be performed in a different order. Meanwhile, in some embodiments, one or more of procedures 201 through 211 can be performed approximately simultaneously with each other. Further, one or more of procedures 201 through 211 can be performed as a predicate to one or more other ones of procedures 201 through 211.

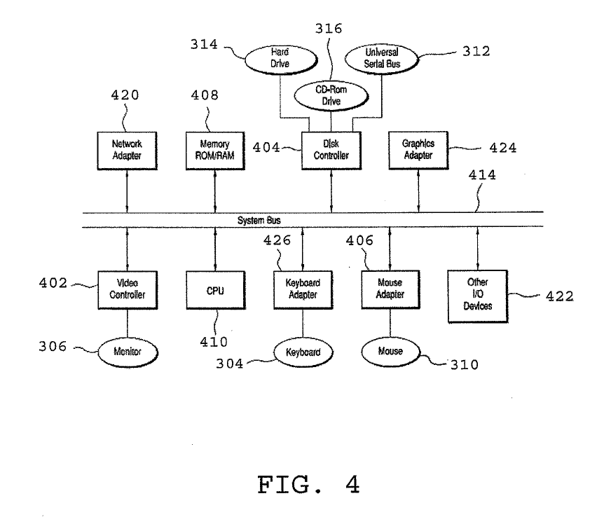

Turning ahead again in the drawings, FIG. 3 illustrates an exemplary embodiment of computer system 300, all of which or a portion of which can be suitable for implementing an embodiment of computer system 112 (FIG. 1) and/or any of various other elements of system 100 (FIG. 1) as well as any of the various procedures, processes, and/or activities of method 200 (FIG. 2). As an example, a different or separate one of chassis 302 (and its internal components) can be suitable for implementing computer system 112 (FIG. 1), etc. Furthermore, one or more elements of computer system 300 (e.g., refreshing monitor 306, keyboard 304, and/or mouse 310, etc.) can also be appropriate for implementing computer system 112 (FIG. 1). Computer system 300 comprises chassis 302 containing one or more circuit boards (not shown), Universal Serial Bus (USB) port 312, Compact Disc Read-Only Memory (CD-ROM) and/or Digital Video Disc (DVD) drive 316, and hard drive 314. A representative block diagram of the elements included on the circuit boards inside chassis 302 is shown in FIG. 4. Central processing unit (CPU) 410 in FIG. 4 is coupled to system bus 414 in FIG. 4. In various embodiments, the architecture of CPU 410 can be compliant with any of a variety of commercially distributed architecture families.

Continuing with FIG. 4, system bus 414 also is coupled to memory storage unit 408, where memory storage unit 408 comprises both read only memory (ROM) and random access memory (RAM). Non-volatile portions of memory storage unit 408 or the ROM can be encoded with a boot code sequence suitable for restoring computer system 300 (FIG. 3) to a functional state after a system reset. In addition, memory storage unit 408 can comprise microcode such as a Basic Input-Output System (BIOS). In some examples, the one or more memory storage units of the various embodiments disclosed herein can comprise memory storage unit 408, a USB-equipped electronic device, such as, an external memory storage unit (not shown) coupled to universal serial bus (USB) port 312 (FIGS. 3-4), hard drive 314 (FIGS. 3-4), and/or CD-ROM or DVD drive 316 (FIGS. 3-4). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 410.

In the depicted embodiment of FIG. 4, various I/O devices such as disk controller 404, graphics adapter 424, video controller 402, keyboard adapter 426, mouse adapter 406, network adapter 420, and other I/O devices 422 can be coupled to system bus 414. Keyboard adapter 426 and mouse adapter 406 are coupled to keyboard 304 (FIGS. 3-4) and mouse 310 (FIGS. 3-4), respectively, of computer system 300 (FIG. 3). While graphics adapter 424 and video controller 402 are indicated as distinct units in FIG. 4, video controller 402 can be integrated into graphics adapter 424, or vice versa in other embodiments. Video controller 402 is suitable for refreshing monitor 306 (FIGS. 3-4) to display images on a screen 308 (FIG. 3) of computer system 300 (FIG. 3). Disk controller 404 can control hard drive 314 (FIGS. 3-4), USB port 312 (FIGS. 3-4), and CD-ROM drive 316 (FIGS. 3-4). In other embodiments, distinct units can be used to control each of these devices separately.

In some embodiments, network adapter 420 can comprise and/or be implemented as a WNIC (wireless network interface controller) card (not shown) plugged or coupled to an expansion port (not shown) in computer system 300 (FIG. 3). In other embodiments, the WNIC card can be a wireless network card built into computer system 300 (FIG. 3). A wireless network adapter can be built into computer system 300 by having wireless communication capabilities integrated into the motherboard chipset (not shown), or implemented via one or more dedicated wireless communication chips (not shown), connected through a PCI (peripheral component interconnector) or a PCI express bus of computer system 300 (FIG. 3) or USB port 312 (FIG. 3). In other embodiments, network adapter 420 can comprise and/or be implemented as a wired network interface controller card (not shown). Accordingly, communication module 113 (FIG. 1) can comprise a network adapter similar or identical to network adapter 420.

Although many other components of computer system 300 (FIG. 3) are not shown, such components and their interconnection are well known to those of ordinary skill in the art. Accordingly, further details concerning the construction and composition of computer system 300 and the circuit boards inside chassis 302 (FIG. 3) are not discussed herein.

When computer system 300 in FIG. 3 is running, program instructions stored on a USB-equipped electronic device connected to USB port 312, on a CD-ROM or DVD in CD-ROM and/or DVD drive 316, on hard drive 314, or in memory storage unit 408 (FIG. 4) are executed by CPU 410 (FIG. 4). A portion of the program instructions, stored on these devices, can be suitable for carrying out at least part of system 100 (FIG. 1) as well as any of the various procedures, processes, and/or activities of method 200 (FIG. 2).

Although computer system 300 is illustrated as a desktop computer in FIG. 3, there can be examples where computer system 300 may take a different form factor while still having functional elements similar to those described for computer system 300. In some embodiments, computer system 300 may comprise a single computer (e.g., a personal computer, a notebook computer, a workstation, a handheld computer such as a personal digital assistant, a mobile phone, a smart phone, etc.), a single server, or a cluster or collection of computers or servers, or a cloud of computers or servers. Typically, a cluster or collection of servers can be used when the demand on computer system 300 exceeds the reasonable capability of a single server or computer. In many embodiments, computer system 112 (FIG. 1) can comprise a single server, or a cluster or collection of computers or servers, or a cloud of computers or servers.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 201-211 of FIG. 2 may be comprised of many different procedures, processes, and activities and be performed by many different modules, in many different orders, that any element of FIGS. 1-4 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed:

1) A system comprising:
an inventory database aggregating multiple available outdoor advertising units; and
a proposal generator configured to communicate with the inventory database, the proposal generator comprising:
a criteria definition module defining one or more criteria from which to select one or more outdoor advertising units, the one or more outdoor advertising units being suitable for implementing an advertising campaign associated with a buyer;
an information gatherer module defining information related to the buyer and the advertising campaign;
a unit inventory searcher module providing a selectable pool of outdoor advertising units from the multiple available outdoor advertising units based on the one or more criteria;
a unit selector module selecting the one or more outdoor advertising units from the selectable pool of outdoor advertising units;
a reference locations definition module defining at least one reference location;
a mapper module mapping the one or more outdoor advertising units and the at least one reference location to a map;
a proposal assembler module assembling (a) the information related to the buyer and the advertising campaign, (b) the map, and (c) the one or more outdoor advertising units into a proposal;
a proposal viewer module providing access to the proposal; and
a notification module providing notification of the proposal to one or more recipients.

2) The system of claim 1 wherein:
the multiple available outdoor advertising units are associated with one or more sellers of outdoor advertising units.

3) The system of claim 2 wherein at least one of:
the one or more recipients are associated with the buyer;
the one or more recipients comprise the buyer; or
the one or more recipients comprise at least one of the one or more sellers.

4) The system of claim 1 wherein:
at least part of the proposal generator is operable at a computer system.

5) The system of claim 4 further comprising:
the computer system.

6) The system of claim 4 further comprising:
a communication module, the communication module permitting the proposal generator to communicate with one or more other computer systems.

7) The system of claim 1 wherein:
the multiple available outdoor advertising units comprise at least two of: (a) one or more available aerial advertising units; (b) one or more available billboard advertising units; (c) one or more available wall-scape advertising units; (d) one or more available digital video advertising units; (e) one or more available indoor signage advertising units; (f) one or more available mobile advertising units; (g) one or more available phone booth advertising units; (h) one or more available poster advertising units; (i) one or more available street furniture advertising units; (j) one or more available transit advertising units; or (k) one or more available urban panel advertising units.

8) The system of claim 1 wherein:
the one or more criteria comprise at least one of: (a) a budget of the buyer; (b) an advertising campaign start date; (c) an advertising campaign end date; (d) a requested response date; (e) one or more advertising campaign regions; (f) one or more advertising campaign media types; or (g) other advertising campaign details.

9) A system comprising:
an inventory database means for aggregating multiple available outdoor advertising units; and
a proposal generator configured to communicate with the inventory database, the proposal generator comprising:
a criteria definition means for defining one or more criteria from which to select one or more outdoor advertising units, the one or more outdoor advertising units being suitable for implementing an advertising campaign associated with a buyer;
an information gatherer means for defining information related to the buyer and the advertising campaign;
a unit inventory searcher means for providing a selectable pool of outdoor advertising units from the multiple available outdoor advertising units based on the one or more criteria;
a unit selector means for selecting the one or more outdoor advertising units from the selectable pool of outdoor advertising units;
a reference locations definition means for defining at least one reference location;
a mapper means for mapping the one or more outdoor advertising units and the at least one reference location to a map;
a proposal assembler means for assembling (a) the information related to the buyer and the advertising campaign, (b) the map, and (c) the one or more outdoor advertising units into a proposal;
a proposal viewer means for providing access to the proposal; and
a notification means for providing notification of the proposal to one or more recipients.

10) The system of claim 9 wherein:
the multiple available outdoor advertising units are associated with one or more sellers of outdoor advertising units.

11) The system of claim 9 wherein:
at least part of the proposal generator is operable at a computer system.

12) The system of claim 11 further comprising:
the computer system.

13) A method for generating a proposal, at least part of the method being implemented via execution of computer instructions configured to run at one or more processing modules and configured to be stored at one or more memory storage modules of a computer system, the method comprising:
executing one or more first computer instructions to define one or more criteria used for selecting one or more outdoor advertising units, the one or more outdoor advertising units being suitable for implementing an advertising campaign associated with a buyer;
executing one or more second computer instructions defining information related to the buyer and the advertising campaign;
executing one or more third computer instructions defining a selectable pool of outdoor advertising units based on the one or more criteria, wherein the selectable pool of outdoor advertising units is defined from multiple available outdoor advertising units managed by one or more inventory management systems;
executing one or more fourth computer instructions selecting the one or more outdoor advertising units from the selectable pool of outdoor advertising units;
executing one or more fifth computer instructions mapping the one or more outdoor advertising units at a map;
executing one or more sixth computer instructions assembling the information related to the buyer and the advertising campaign, the map, and the one or more outdoor advertising units into the proposal; and
executing one or more seventh computer instructions notifying one or more recipients of the proposal;
wherein:
the computer instructions comprise the one or more first, second, third, fourth, fifth, sixth, and seventh computer instructions.

14) The method of claim 13 further comprising:
executing one or more eighth computer instructions defining at least one reference location, the one or more criteria comprising the at least one reference location; and
executing one or more ninth computer instructions mapping the at least one reference location at the map;
wherein:
the computer instructions further comprise the one or more eighth and ninth computer instructions.

15) The method of claim 14 wherein:
executing the one or more eighth computer instructions comprises executing one or more tenth computer instructions to receive the at least one reference location from the buyer.

16) The method of claim 13 wherein:
executing the one or more first computer instructions comprises executing one or more eighth computer instructions to receive the one or more criteria from the buyer.

17) The method of claim 13 wherein:
executing the one or more seventh computer instructions comprises executing one or more eighth computer instructions notifying the one or more recipients of the proposal via at least one of electronic mail messaging, short message service text messaging, or social network messaging.

18) The method of claim 13 further comprise:
executing one or more eighth computer instructions defining at least one of the one or more recipients;
wherein:
the computer instructions further comprise the one or more eighth computer instructions.

19) The method of claim 13 wherein:
executing the one or more third computer instructions comprises providing the multiple available outdoor advertising units to be comprised of at least two of: (a) one or more available aerial advertising units; (b) one or more available billboard advertising units; (c) one or more available wall-scape advertising units; (d) one or more available digital video advertising units; (e) one or more available indoor signage advertising units; (f) one or more available mobile advertising units; (g) one or more available phone booth advertising units; (h) one or more available poster advertising units; (i) one or more available street furniture advertising units; (j) one or more available transit advertising units; or (k) one or more available urban panel advertising units.

20) The method of claim 13 wherein:
executing the one or more first computer instructions comprises providing the one or more criteria to be comprised of at least one of: (a) a budget of the buyer; (b) an advertising campaign start date; (c) an advertising campaign end date; (d) a requested response date; (e) one or more advertising campaign regions; (f) one or more advertising campaign media types; or (g) other advertising campaign details.
